(19) United States
(12) Patent Application Publication
(10) Pub. No.: US 2003/0230488 A1
(43) Pub. Date: Dec. 18, 2003

(54) Microfluidic device preparation system

(76) Inventors: Lawrence Lee, Sunnyvale, CA (US); Torlief O. Bjornson, Gilory, CA (US)

Correspondence Address: Stephen C. Macevicz, ACLARA BioSciences, Inc., 1288 Pear Avenue, Mountain View, CA, 94043, US

(21) Appl. No.: 10/172,171

(22) Filed: Jun. 13, 2002

(51) Int. Cl. G01N 27/26; G01N 27/447

(52) U.S. Cl. 204/453; 204/450; 210/604; 204/600

(57) ABSTRACT

Devices, systems and methods for filling and processing microfluidic devices are disclosed. A device of the system comprising a priming block is disclosed, that functions to drive fluid into a plurality of separation networks in a microfluidic device, using air pressure or electromotive force. The priming block may be incorporated into a microfluidic device preparation system additionally comprising a platform for positionally holding the microfluidic device and a sample array and fluid dispensing modules that are movable in any direction relative to the platform of the microfluidic device. The preparation system may be further incorporated into a greater system that performs processing functions either preceding or following the preparation system, including sample array preparation, and processing and analysis of the samples contained in the prepared microfluidic devices. Methods for operation of the various components of the disclosed systems are also provided.

### TECHNICAL FIELD

The present invention relates to the preparation of microfluidic devices for use, more specifically to a system for filling microchannels on a microfluidic device with a separation medium, and transferring samples and other liquid reagents to reservoirs in the devices that are fluidly connected to the microchannels.

### BACKGROUND OF THE INVENTION

The present explosive growth in knowledge in the fields of genomics, proteomics, and combinatorial chemistry has presented a number of challenges to the scientific community. The number of compounds to analyze and compound interactions to assess presents a daunting task. However, the rewards include the expansion of knowledge and the ability to diagnose and treat diseases.

Opportunities in the field of genomics have expanded dramatically with completion of a first version of the human genome sequence. The human genome contains between 30,000 and 70,000 genes and at least 3 million single nucleotide polymorphisms (SNPs). Many of the 2.1 million adverse reactions to prescribed medicines may be correlated to individual SNP markers. Identification and analysis of these markers will allow prediction of certain potential adverse drug reactions, providing for individual tailoring of medications according to a patient's distinct genetic makeup.

Similarly, the field of proteomics has expanded as a result of obtaining a sequence of the human genome. Each gene encodes at least one product, usually a protein with a distinct structure, function and interrelationship to other proteins and compounds. The protein products of all of the genes in a genome are collectively referred to as the “proteome.” Understanding the set of interrelationships within the proteome will provide an invaluable map to the complex pathways and functions of the human cell.

Like the genomic revolution, combinatorial chemistry technologies have vastly expanded the need for analytical throughput. Combinatorial chemistry allows the production of large libraries of small molecules. Hundreds of thousands of compounds can be generated, and identification of compounds as candidate therapeutic agents requires that each be analyzed separately. Secondary screens, also preferably performed in a high throughput mode, would be needed to analyze other properties of the candidate compounds, such as solubility and toxicity.

Analytical systems that allow rapid processing of large numbers of samples, i.e., “high throughput,” will be required to capitalize on the opportunities presented by the above applications. Ideally, these systems will also allow analysis of samples in very small volumes, in order to reduce costs and provide for testing samples that are in limited supply. Where assays are to be analyzed by electrophoresis, high-throughput, low-volume analysis has been enabled by development of various microfluidic systems. The first generation of such systems was based on the use of very small volume glass capillary tubes that defined the separation path. Later improvements on this technology included systems capable of analyzing an array of glass capillaries in parallel. Microfabrication of planar devices containing very high densities of multiple capillary-dimensioned microchannels have further improved analysis throughput. The small cross-sectional dimensions of these microfluidic systems confer two critical advantages. First, the volumes of samples required for analysis is greatly reduced. Second, separations can be performed very rapidly because the high surface-to-volume ratio of a microchannel of capillary dimensions provides efficient heat dissipation, allowing the use of high voltages for separation.

While the small volumes and high voltages enabled by microfluidic systems makes rapid electrophoretic separations possible, using these devices in truly high throughput applications requires that the manual labor necessary for preparing and using these devices be reduced or eliminated by automation. Towards that end, efforts to fully integrate the multiple operations required, from sample handling through data analysis, will contribute to realizing the potential benefits of microfluidics to the current challenges facing the fields of genomics, proteomics, and drug discovery. An automated system ideally would prepare the microfluidic device for use, and transfer samples to the prepared device. This system could be further integrated into a larger system that automates the sample preparation, conducts the separations, and collects and analyses data from the samples. Such a system would be able to produce analytical data from input compounds, cell preparations, or other starting sample material.

Two steps are needed for preparing microchannels in a microfluidic device for use. First, the microchannels must be filled with a separation medium. The filled microchannels must be free of bubbles, which will block current flow, and distort the separation. Next, samples and buffers must be introduced at reservoirs connected to the microchannels. For high-throughput applications, these preparation processes are desirably automated and controlled in a manner that is both rapid and efficient.

One of the critical features of microfluidic devices used for electrophoretic separations is the extremely small cross-sectional area of the microchannels, which provide for analysis of small sample volumes. However, the very large surface-to-volume ratio of the microchannel inherent in this feature can cause problems such as bubble formation during filling the microchannels.

Utilization of microfluidic devices for high-throughput applications will require a system that is capable of efficiently filling a large number of separation microchannels simultaneously, and monitoring the accuracy of the filling process. In particular, the system should be adaptable to arrays conforming to standard automation geometries. Transfer steps should ideally be minimized in order to save time and reduce potential contamination. Where such a system is further integrated into a complete system for conducting all of the process required for an analysis, the potential use of microfluidics for true high throughput analysis will be realized.

### SUMMARY OF THE INVENTION

The present invention provides devices, systems and methods for preparing a microfluidic separation device for use, including filling separation networks with a separation medium, transferring samples and reagents to reservoirs connected to the separation networks for analysis, and analyzing the samples contained in a prepared microfluidic separation device.

One embodiment of the invention provides a system for filling a plurality of fluid networks contained in a microfluidic device. One embodiment of this system comprises (i) a platform for holding the microfluidic device at a fixed position, and optionally a sample array in a second position, (ii) one or more fluid dispensing modules for filling and further preparing the microfluidic device for use, which can be moved to the appropriate positions for function, and (iii) a priming block that is able to connect with openings to separation networks and drive fluid into them to fill them.

The means used by the priming block to drive fluid into the separation networks may include one or both of air pressure and electromotive force. In some embodiments where air pressure is employed, the priming block will further comprise a compressible material that serves to seal the priming block around the openings to separation networks, and the system will additionally include a source of pressurized air, connected to the priming block by a pressure line, where the pressure line will also include a valve to regulate delivery of pressurized air to the priming block. In certain embodiments where an electromotive force is used for driving fluid, the priming block will further comprise an electrode that is inserted by the priming block into medium contained in a reservoir, and the system will include an electrically grounded plane positioned against the face of said microfluidic device opposite of said priming reservoir and a source of power that can be delivered to the electrodes of the priming block.

Additional components that may be included in the system are (i) means for separately regulating the temperature of the microfluidic device and/or the sample array when they are positioned on the system platform, (ii) means for regulating the temperature of the fluid-dispensing module(s), and (iii) a wash station that is accessible to the fluid dispensing module(s). This wash station may be heatable, and may include means for providing a flow of rinse liquid through the wash station.

One fluid-dispensing module useful in the system is an aspiration/dispense unit. This unit comprises multiple tips that can be used for moving fluids between wells in a sample array and reservoirs on a microfluidic device when they are positioned on the system platform. This aspiration/dispense unit may comprises eight tips mounted in parallel with a spacing of 9 mm between adjacent tips, or 16 tips mounted in parallel with a spacing of 4.5 mm between adjacent tips. The tips of the aspiration/dispense unit may be operated using positive displacement.

A second fluid-dispensing module useful in the system is a separation medium dispenser with one or more medium dispensing lines, each line terminating at a medium dispense tip. The tips of the separation medium dispenser can be moved to reservoirs on the microfluidic device in order to dispense separation medium.

The system may further comprise means for determining if the separation networks have been filled properly, e.g., are operational for electrophoretic separations, based on monitoring a physical property of the networks. Some properties that may be used for this purpose include electrical resistance or capacitance, physical imaging, light transmission, or sonic properties. For example, where such a determination is based on electrical resistance, the system will further comprise a power source for applying a voltage across the filled fluid networks and a detector for monitoring the current generated by the voltage. Where the determination is based on light transmission, the systems will further comprise a light source for directing light across the filled fluid networks, and a detector for monitoring the light transmitted across the filled fluid networks, wherein the light source and the detector are disposed on opposite sides of the networks.

In order to more fully integrate and automate operation of the system, it may also comprise a gantry positioned above the platform, wherein the platform and gantry may be moved relative to each other along a first direction, a carriage, which is moveably mounted to the gantry, and which is moveable on the gantry in a direction perpendicular to the first direction, and a second means for moveably mounting the priming block and/or the fluid dispensing module to the carriage, such that they may be moved in a direction perpendicular to the plane of the platform. The system may further include fluid-containing cartridges that provide fluid to the fluid-dispensing modules. Where a carriage is employed for movement along the gantry, the carriage may have a hinged compartment fitted to receive the fluid-containing cartridges.

The system for filling separation networks in microfluidic devices may be combined with additional processing modules to form greater systems that more fully integrate a series of processes performed on the microfluidic device. Such additional modules may include (i) a sample preparation module that functions to prepare a sample array for use on the microfluidic device filling system, (ii) a separation/detection module that is capable of conducting separations on samples contained within the microfluidic device and detect the separated components of the samples, and (iii) an analysis module that collects and analyzes data obtained from the detection. The greater systems may further comprise automated means for transferring sample arrays and microfluidic devices between the modules.

Further embodiments of the present invention provide methods for preparing separation networks in a microfluidic device for a separation of components of a sample. Steps in the methods comprise (i) dispensing separation medium into priming reservoirs connected to the separation networks, (ii) sealing a priming block against the priming reservoirs, (iii) driving fluid into the separation networks with the priming block to fill them, and (iv) transferring samples from a sample array to sample reservoirs connected with the filled separation networks. After transferring samples, the method may include the step of transferring the microfluidic device to an analyzer for separation and analysis of samples in the prepared separation networks.

The methods may further include determining the operativity of each of said filled separation networks for electrophoretic separations prior to transferring samples to the microfluidic device, by monitoring any of a number of physical properties, including electrical resistance or capacitance, physical imaging, light transmission, or sonic properties.

Where a microfluidic device is found to contain an inoperative filled separation network, the methods may further include any of the following steps of (i) repeating the filling steps of dispensing, sealing, and driving, (ii) recording the position(s) of the inoperative separation network(s), or (iii) discarding the microfluidic device.

Any or all of the steps of the method may be conducted automatically using programmed protocols.

### BRIEF DESCRIPTION OF THE DRAWINGS

FIGS. 1A-F show various views of the microfluidic device fill station and components of the system. FIG. 1A is an isometric view, FIG. 1B a top view, and FIG. 1C a back isometric view of the system. FIGS. 1D-F show bottom views of alternate embodiments of the priming block of the system.

FIGS. 2A-C illustrate some designs of microfluidic devices for which the invention is useful.

FIGS. 3A-F show various views of the components of an aspiration/dispense unit. FIGS. 3A and B are perspective views of the unit. FIG. 3C is a cross-sectional view of a filled tip of the tool of FIG. 3A. FIG. 3D is a side view cross-section of the tool of FIG. 3A. FIG. 3E is an exploded view of the shafts and diaphragms of the aspiration/dispense tool. FIG. 3F is a side view of the image of FIG. 3E.

FIGS. 4A-E illustrate the aspiration/dispense unit. FIG. 4A is a perspective view of the unit. FIG. 4B is a perspective view, and FIG. 4C a cross-sectional view of the reagent cartridge with plunger. FIG. 4D is a front view of the reagent cartridge with plunger rack. FIG. 4E is a top view of the reagent unit.

FIGS. 5A and B are plan views of carriage embodiments. FIG. 5A is a side view of the separation medium dispenser tool connected to the carriage of FIG. 1A. FIG. 5B is a carriage embodiment illustrating the use of a single air source for supplying displacement force for multiple tools.

FIGS. 6A-I show views of various steps in preparing a microfluidic device for use. FIG. 6A is perspective view of showing a liquid dispense step.

FIG. 6B is a side cross-section view of the process shown in FIG. 6A. FIG. 6C is a perspective view of the active priming step. FIG. 6D is a side cross-section view of the active priming step. FIG. 6E is a perspective view of a buffer dispense step. FIG. 6F is a side cross-section view of a buffer dispense step. FIG. 6G is a perspective view of the cleaning of the dispenser tips. FIG. 6H is a side cross-section view of the cleaning of the dispenser tips. FIG. 6I is a plan for the transfer of samples.

FIGS. 7A and B are perspective views of an enclosed microfluidic device preparation and analysis system with an open access panel. FIG. 7A shows set-up of the system. FIG. 7B shows the system after set-up.

FIG. 8 is a plan view of a sample preparation and analysis system including an automated sample preparation system, a microfluidic device preparation system, and a microfluidic device analysis system.

FIG. 9 is an integrated work flowchart for a sample preparation and analysis system.

### DETAILED DESCRIPTION

Definitions

The following definitions are offered in order to more explicitly define the terms used in disclosure of the present invention:

As used herein, the term “microfluidic device” refers to a small microfabricated analytical device having enclosed channels with internal cross-sectional dimensions less than 1 mm, generally ranging from 0.5-500 μm, more generally from 25-100 μm. Such small-scale channels are referred to as “microchannels.” The cross-sectional shape of a microchannel may be round, rectangular, square, or other shape. Microfluidic devices may be used for separation and/or analysis of biological or chemical samples or reactions. In certain applications, a plurality of intersecting microchannels may be employed, forming a “separation network” for a single analysis. Microfluidic devices designed for high throughput analysis typically contain large numbers of such separation networks, and are thus able to perform large numbers of analyses simultaneously. Examples of such microfluidic devices include the various plastic LabCards™ produced by ACLARA BioSciences Inc. (Mountain View, Calif.). An overview of progress in microfluidic device design is given in Boone, et al., (2002) “Plastic Advances Microfluidic Devices,” Analytical Chemistry 74 (3), pp.78A-86A. In addition to enclosed microchannels, microfluidic devices also typically comprise additional features, including “reservoirs” or “ports,” which serve both to connect enclosed microchannels to a surface of the device, and to hold a volume of liquid, such as buffer or sample material. Microfluidic devices may also comprise integrated electrodes for electrophoretic separation, windows for light transmittance or filtration, thermal coupling means, or other features, as required for the particular analysis being performed.

The term “fluid network,” as used in this disclosure, refers to a complete set of features within a microfluidic device that are in internal fluid communication with each other. A “fluid network” may comprise one or multiple “separation networks.” For example, where a “separation network” comprises a single microchannel that is externally and fluidly accessible by two reservoirs, the “fluid network” is composed of the two reservoirs and the single microchannel. Similarly, where a “separation network” comprises two intersecting microchannels that are externally and fluidly accessible by four reservoirs, the “fluid network” is composed of the four reservoirs and the two microchannels. Multiple “separation networks” may share a feature, including a shared reservoir or a shared microchannel. In this embodiment, the “fluid network” is composed of the multiple “separation networks,” including all of the shared and unshared features of the individual “separation networks.” Two “fluid networks,” by definition, will have no shared features that provide a fluid connection between them. Where a “fluid network” comprises a single “separation network,” the terms become functionally equivalent.

As used herein, the term “priming reservoir” refers to a reservoir that is part of a fluid network, and is the reservoir with which the priming block forms an operative connection in order to drive fluid into the fluid network.

As used herein, the term “positive displacement” refers to a means of dispensing a known quantity of fluid using pump that operates by revolution or cycling of its pumping elements within a stationary casing.

The term “module” as used in the present invention refers to a subsystem that performs a subset of discrete steps in an overall process. In the course of conducting a sample analysis, various steps are required, including preparation of sample materials, preparation of devices used for analysis of the sample, addition of sample material to the device, handling and conducting an operation on the device, and collecting the results from the analysis. Modules of the present invention may conduct one or more of the various steps of the overall process. Multiple modules may be combined into a more integrated system.

System Components

The present invention includes a number of different modules that may be used in the preparation and use of microfluidic devices. A first module functions to prepare a microfluidic device for use. Other modules include a sample preparation module that functions to assemble sample or reagent arrays, and an analyzer that conducts electrophoretic separations on a prepared microfluidic device, and collects and analyzes data obtained from the separations. These modules may either be integrated into a single apparatus, or may be independent, and suitably positioned to allow use of automated means, such as a transfer robot, for transfer of sample arrays and microfluidic devices between the modules. Such a system would provide a powerful tool for improving the throughput of sample analysis.

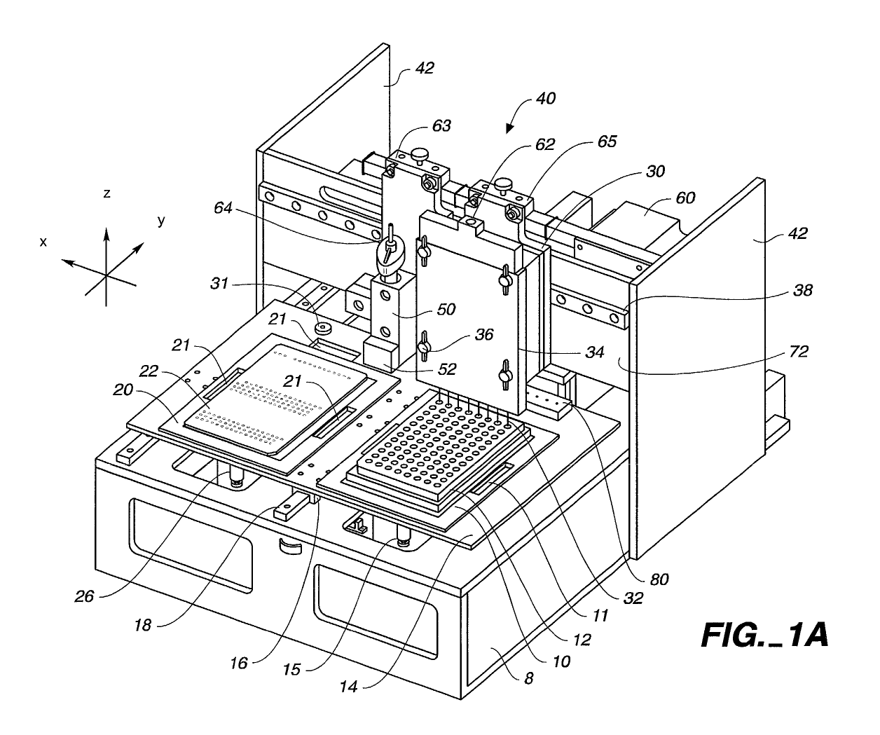

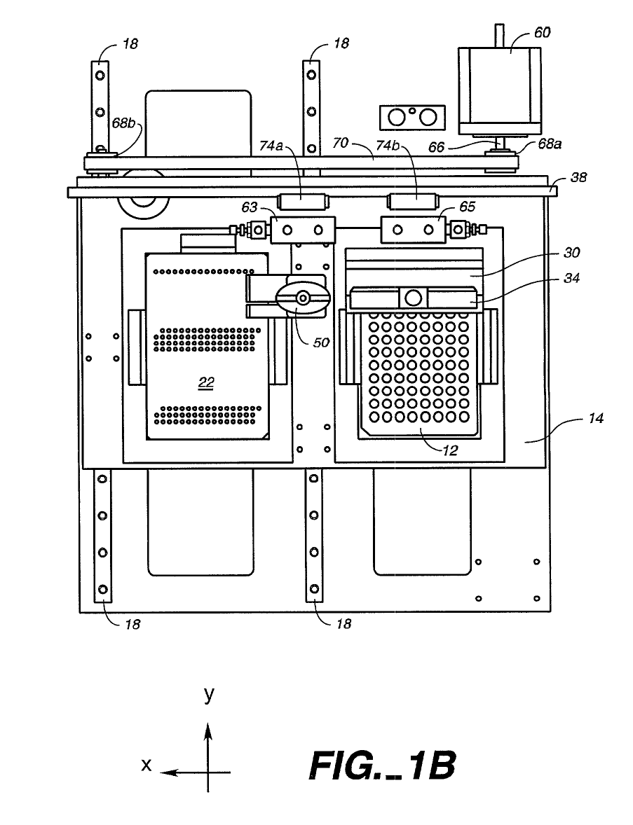

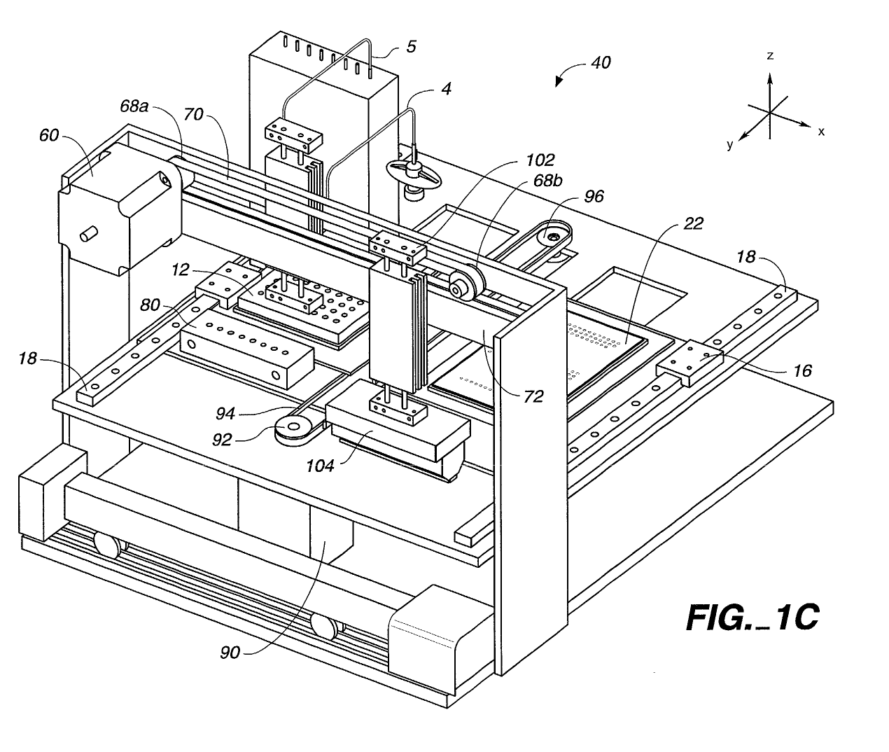

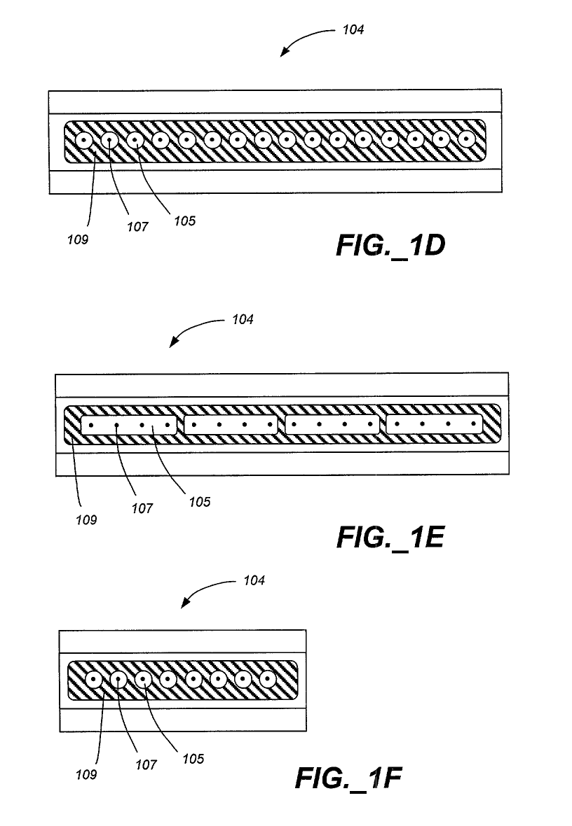

The first module, illustrated in FIGS. 1A-C, is a system for preparing microfluidic devices containing a plurality of separation microchannels for use, including addition of a separation medium into microchannels in the device, and addition of samples and reagents into reservoirs on the microfluidic device that are in fluid communication with microchannels. The prepared microfluidic device can then be processed and analyzed without further addition of materials.

The components of the module described in conjunction with FIGS. 1A-1C allow for complete preparation of microfluidic device separation networks. The separation medium dispenser 50 initially dispenses liquid into a number of different priming reservoirs, each opening to a fluid network. Priming block 104 is then moved over the microfluidic device 12 and individual channels on priming block 104 seal over each opening. An active force is then used to move the liquid into the microchannel. A preferred mode of active force exerted from a chamber sealed over an opening into a microchannel is pressure. Alternatively, an electromotive force used, either alone or in combination with pressure. Other active loading means, such as use of a vacuum are also envisioned.

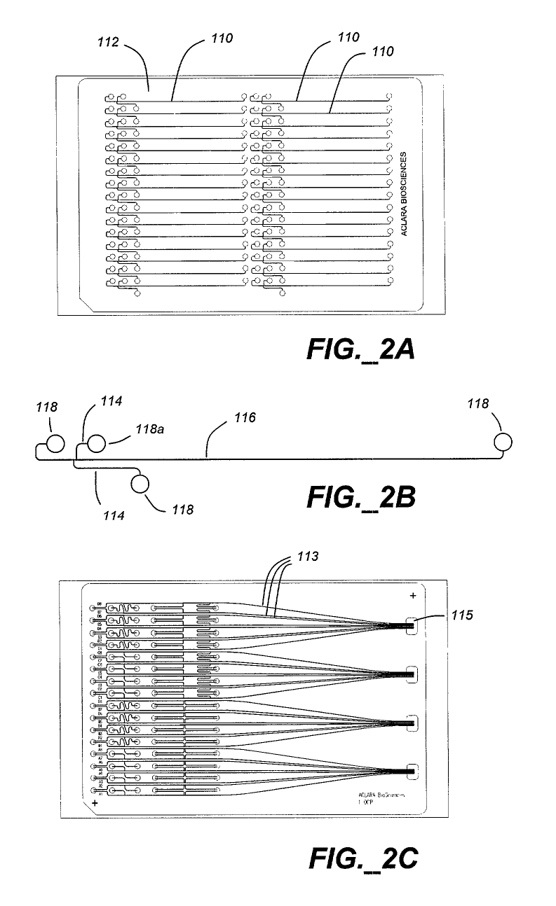

One microfluidic device that may be used with the present invention is a 32-microchannel LabCard™, illustrated in FIG. 2A. This 32-microchannel microfluidic device comprises an array of 32 duplicate, unconnected separation networks 110 in two rows of 16. Each separation network is designed to perform an electrophoretic separation completely isolated from all of the other separation networks on the card. A close-up view of a single separation network of the 32-microchannel microfluidic device is shown in FIG. 2B. Each separation network comprises two arms 114 of a short injection microchannel that intersect a longer separation microchannel 116. Both microchannels of all 32 separation networks are enclosed within the substrate 112 (FIG. 2A) of the card. Each end of both microchannels terminates in a reservoir 118 that is open to one external surface of the card. Liquid materials, such as separation media and buffer are introduced to the microfluidic device through any of the reservoirs 118, and samples will be introduced into one of the reservoirs 118a at the terminus of the short injection microchannels 114. The liquid added to a reservoir may then flow into connected microchannels within a single fluid network. Use of the system with a 96-microchannel microfluidic device or other device configurations is possible, and would not require alteration of the preparation module. Unlike the 32-microchannel LabCard, some types of microfluidic devices are designed to have multiple separation networks in fluid communication with each other. The systems and methods of the present invention may also be employed with microfluidic devices incorporating this design feature. One example of such a device is the “fan” card shown in FIG. 2C. In this design, 8 separation networks 113 are connected at a common priming reservoir 115. Four of such interconnected separation network arrays are included in the card illustrated. The microchannels of this device are filled by adding separation medium to the four priming reservoirs, followed by applying the priming block to these reservoirs to force the separation medium into the 32 separation networks connected to the four priming reservoirs. Thus, in filling the separation networks of a microfluidic device, addition of liquid to a single reservoir may serve to fill either one or a plurality of separation microchannels.

Referring to FIG. 1A, a microfluidic device holding stage 20 and a sample holding stage 10 are mounted on a platform 14. Both stages are affixed to the platform in specific positions such that they move with the platform. Microfluidic device holding stage 20 holds a microfluidic device 22, pictured as a 32-microchannel LabCard. The microfluidic device holding stage 20 is designed to securely fit the microfluidic device, holding it in a fixed position for preparation. One design for holding the device uses notches 21 positioned on three sides of the device 22 to hold it at a precise location on the holding stage 20. This allows for simplified insertion and removal of the microfluidic device 22 from the holding stage 20, either manually or by automation. The device may similarly be held by other standard positioning means, such as alignment pins, footprint recesses, or guide edges. As with microfluidic device holding stage 20, sample-holding stage 10 has notches 11 on three sides of sample array 12 to provide proper positioning for insertion and removal of sample array 12. In addition to the notches, a vacuum or other suitable mechanical means may be used to secure a sample array or microfluidic device into a precise location. This precise positioning, needed for both the microfluidic device and the sample holder, allows for precise localization for liquid transfer.

Microfluidic devices that conform to standard microplate dimensions are generally employed, further providing for compatibility with commercially available automation equipment. Sample holding stage 10 holds a 96-well microplate 12 containing a number of liquid samples for analysis. Use of microplates of other standard well configurations, including 384-well or higher density microplates is also contemplated. Samples may comprise nucleic acids, proteins or polypeptides, cell preparations, chemical compound screening mixtures or other materials to be analyzed.

In one embodiment, temperature regulation devices 15 and 26 are secured below sample holding stage 10 such that device 15 moves with platform 14. Device 15 is able to heat or cool sample array 12, and device 26 is able to heat or cool or the microfluidic device 22, independently to a specified temperature, e.g., temperatures ranging from 4-40° C. The sample array may be incubated in order to conduct an assay. The microfluidic device may be incubated in order to facilitate flow of a separation material, such as low melting point agarose, into the microchannels. One preferred means of temperature regulation is provided by devices using a Peltier thermoelectric heat pump, which is a small solid-state device that can provide rapid and precise heating or cooling as required.

One embodiment of an apparatus for controlling the relative positioning of the sample array and microfluidic device relative to devices used for preparing the microfluidic device is shown in FIG. 1A. This diagram shows sidewalls 42 of the microfluidic device preparation module 40. Walls 42 and shell 8 may be used to secure the microfluidic device preparation module within the housing of a larger system. Platform 14 is mounted on guide 16. Guide 16 is slidably attached to track 18, allowing movement of platform 14 along a y-axis. Track 18 is mounted on shell 8. In FIG. 1C the drive belt 94, which moves platform 14, is shown. Drive belt is held between pulley 92 and pulley 96 at sufficient tension that drive belt 94 does not slip. Motor 90 drives pulley 92, which in turn engages belt 94. Guide 16 affixed to the platform is attached to belt 94. As the belt 94 is moved, the platform will move along the y-axis. Motor 90 may be a precise stepper motor allowing precise movement of platform 14. Such precise movement allows the microfluidic device 22 or sample array 12 on the platform to be moved to a precise location. At this location liquids can be introduced into reservoirs on the microfluidic device that open into microchannels in the device.

Attached between walls 42 is gantry wall 72 positioned above the platform, and connected in a manner that allows movement of the platform relative to the gantry along a first axis (e.g., along the y axis in the figure). A carriage track 38 is moveably mounted to the gantry wall 72, where the direction of motion of the carriage on the gantry is along an axis perpendicular to the direction of motion of the platform. A carriage 30 moves on carriage track 38, providing movement along the x-axis. The carriage 30 acts to carry tools mounted on actuators, moving them as a unit. Each actuator, such as illustrated at 63 and 65, allow for independent movement of their associated tool along the z-axis. The combined movement of the carriage 30, tool actuators 63, 65 and platform 14 allow movement of the tools in all three dimensions (x-y-z movement) relative to objects on the platform 14, wherein motion along all three axes provides for functional access to reservoirs in the microfluidic device and sample array when they are appropriately positioned on the platform. In this manner a tool may be moved downward in the z-axis into wells on sample array 12 and back upward to clear the wells on plate 12. The tool may then be moved in the x-axis to align with the reservoir or reservoirs on the microfluidic device, positioned by platform 14 along the y-axis. The tool may then be lowered along the z-axis to allow the tool to dispense liquid into the reservoirs. The tool may then be raised along the z-axis and moved away from the microfluidic device. The platform may then be moved along the x-axis to align the tool with a new row of wells on the sample array and the process repeated.

As shown in FIG. 1B, the carriage 30 functions to carry tools, such as a priming block for driving fluid into the microchannels of a microfluidic device, and fluid dispensing modules, including an aspiration/dispense unit and a separation medium dispenser. Actuators carrying these tools, such as shown by 63, 65, are each affixed to carriage guides 74a, 74b, respectively. The actuators provide for motion of the tools in a direction perpendicular to the plane of the platform. Carriage guides 74a, 74b are slidably attached to track 38. Carriage guides 74a, 74b are affixed to belt 70, which is tension mounted on pulleys 68a, 68b. Motor 60 rotates shaft 66, which rotates pulley 68a. The motor is preferably a precise stepper motor, which allow for precise incremental movements of carriage 30, allowing for the exact control of the positioning of the tools on this unit.

Tools developed for use on this include a priming block for driving fluid into the microchannels of a microfluidic device, and fluid dispensing modules, including an aspiration/dispense unit for transferring buffer and sample, and a separation medium dispenser, dispensing separation medium for filling the separation microchannels.

Fluid Dispensing Modules

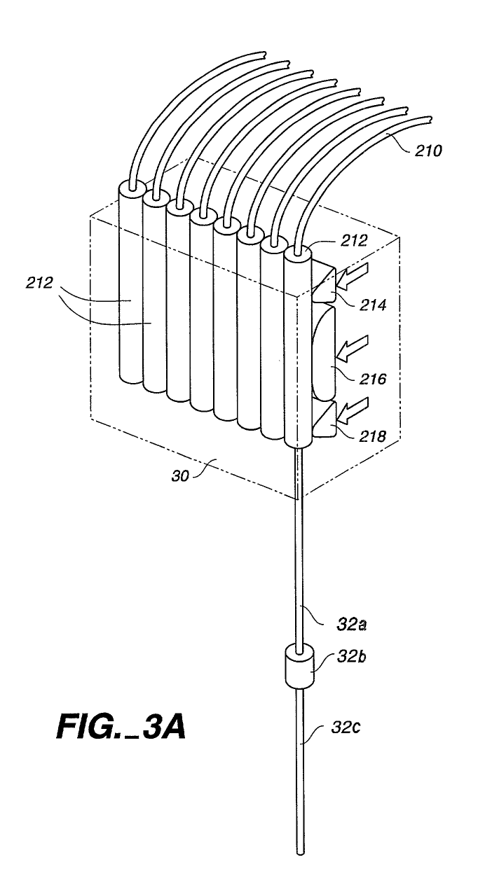

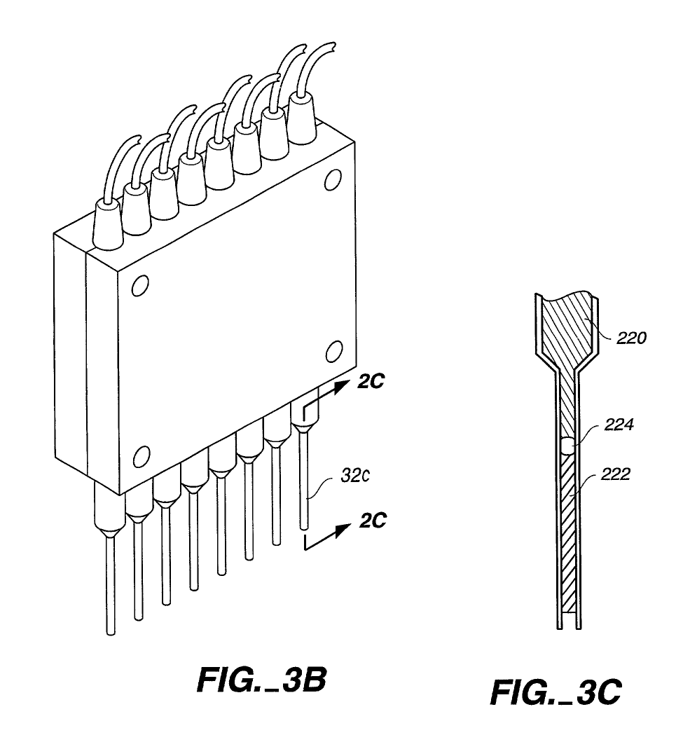

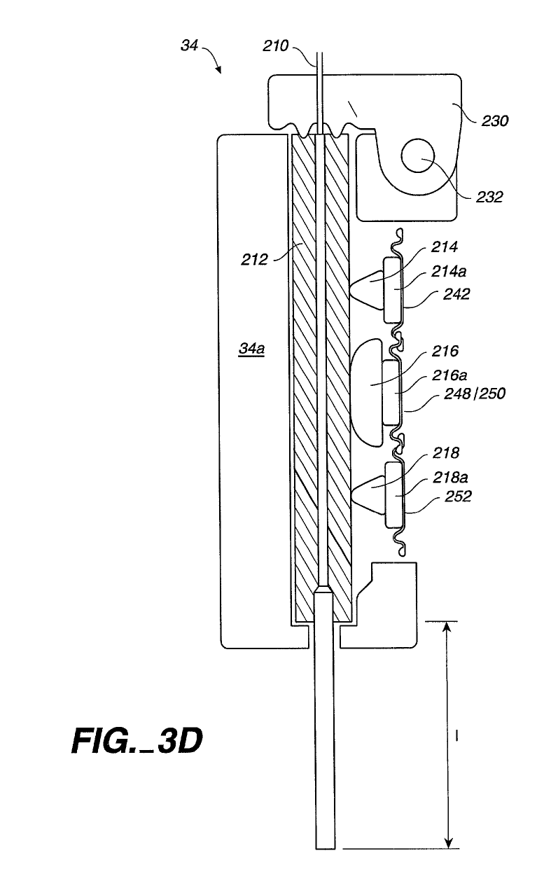

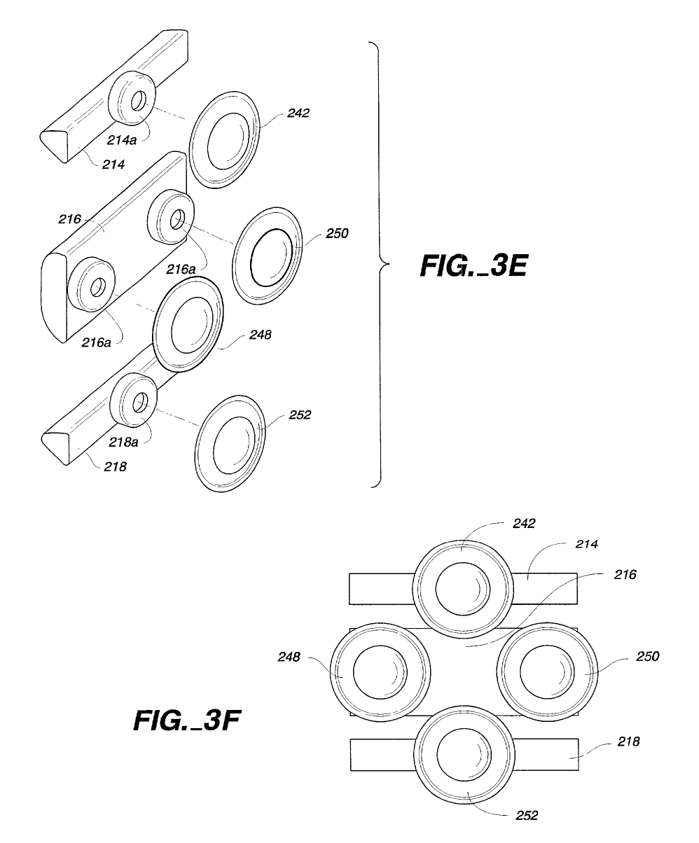

In one embodiment of the present invention, the aspiration/dispense unit enables both the dispensing of a liquid sample and a repetitive dispensing of a buffer without the need for loading buffer into the unit between each dispense. Additionally, a single unit is able to dispense both a liquid sample and a buffer reagent allows a single tool mounted on a carriage to perform multiple tasks, lowering system costs and reducing the weight a carriage would need to transport. One embodiment of an aspiration/dispense tool is illustrated in FIGS. 3A-3D. Alternatively, other types of pumps, including other types of peristaltic pumps, or conventional multi-channel syringe modules, e.g., from Tecan Systems, San Jose, Calif., could also be used.

The aspiration/dispense unit 34, shown in FIG. 1A, is mounted on carriage 30 by the actuator 65. Tips 32 allow for removal of liquid from a sample source, such as samples in a microplate, when actuator 65 lowers tips 32 into contact with liquid samples or reagents. The figure illustrates one possible embodiment in which the aspiration/dispense unit comprises eight individual dispensing tips mounted in parallel with a spacing of 9 mm between adjacent tips. This geometry conforms to the spacing of individual wells in a standard 96-well plate, allowing efficient transfer of a complete row of samples from a 96-well plate to the microfluidic device. Any convenient number of tips may be employed with the aspiration/dispense unit, preferably in numbers that are convenient fractions of a standard 8×12 array, including 12, 16, 96, or other numbers.

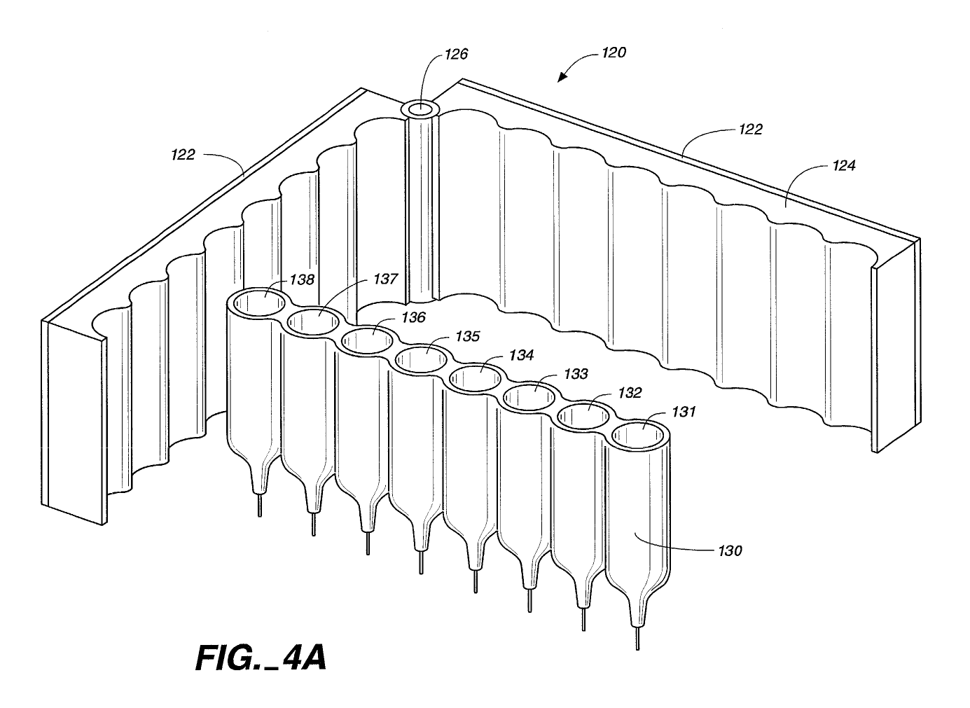

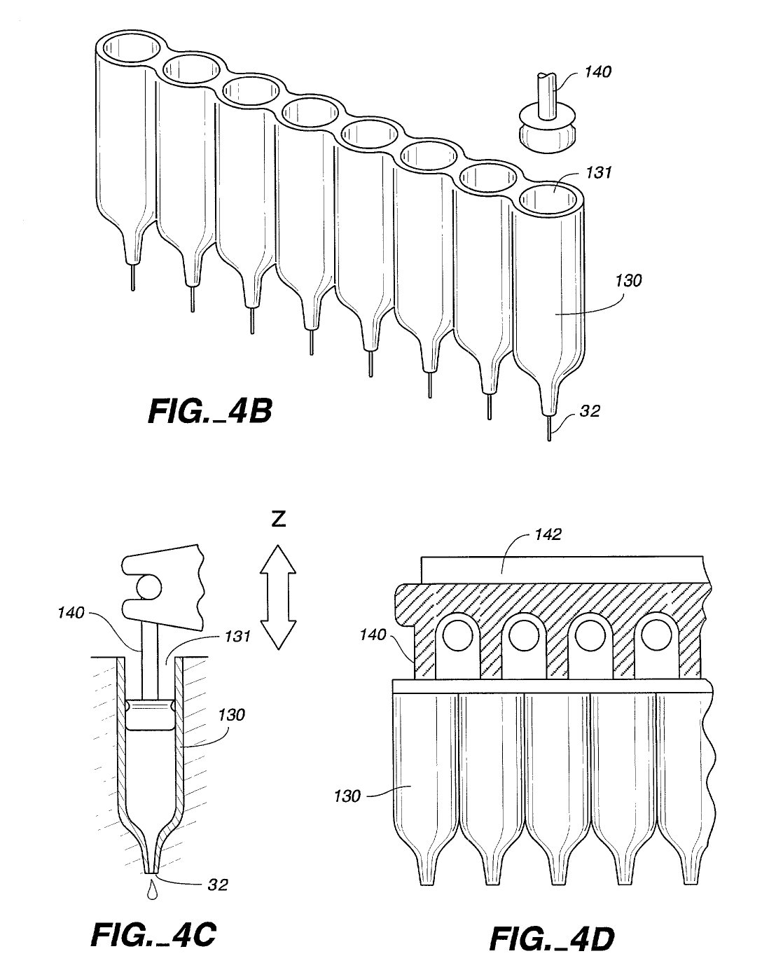

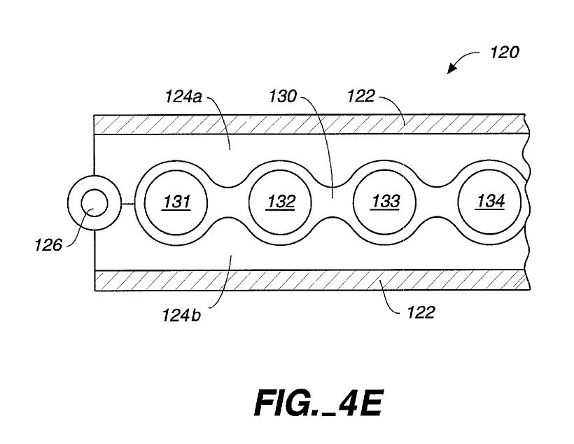

The input port 62 in the aspiration/dispense unit 34 receives an input line for connection to a remote pressure and/or buffer source. The aspiration and dispense functions of this unit may be accomplished by any of several means known of one skilled in the art, including positive displacement, e.g., peristaltic pumping, and pressure, as will be discussed in detail below. Nuts 36 secure the cover of aspiration/dispense unit 34. Removal of this cover allows access to the components of this unit, as detailed in the descriptions below of FIGS. 3 and 4.

In FIG. 3A, a number of tubes 210 bring liquid into peristaltic tubes 212 contained within the housing of carriage 30. Platinum cured, medical grade silicon rubber tubing is a preferred for the peristaltic tubing. Tubing 32a is attached to the end of peristaltic tubes 212. The end of tubing 32a is joined by coupler 32b to needle 32c. Tubing 32a and needle 32c in combination form a dispense tip. Fluid is dispensed from the end of needle 32c. In an alternative embodiment, the needle is mounted directly onto the end of the peristaltic tube 212. The tips may be removable and disposable or may be washed and reused. Hydrophobically coated stainless steel or glass capillary tubing may be used.

Several views of the components of the aspiration/dispense unit are shown in FIGS. 3A, 3D, 3E, and 3F. A number of rams are disposed between tubing 32a and tubes 210 along the length of peristaltic tubes 212 in the aspiration/dispense unit. These rams are used to perform the aspiration and dispense functions by providing positive displacement of liquid. Each ram is positioned adjacent to peristaltic tubes 212, and are contained within housing 34a of aspiration/dispense unit 34 with the peristaltic tubing. Each peristaltic tube 212 is positioned such that one side of the tube is appressed against housing 34a, and the opposite side is in contact with the rams. Housing 34a has a hinged top 230 attached at hinge 232. Hinged top 230 seals to the peristaltic tubes 212 to hold them within housing 34a. When rams are engaged against tube 212, the housing 34a and top 230 prevents tube 212 from deforming or moving. Buffer tube 210 is inserted into hinged top 230, which brings buffer tube 210 into fluid communication with peristaltic tube 212.

The rams include pinch-off ram 214, dispense ram 216 and air gap ram 218, in order in which they are positioned from buffer delivery tube 210 to needle 32c. Pinch-off ram 214 is moved by piston 214a, dispense ram 216 by piston 216a, and airgap ram 218 by piston 218a, and all three are moveable between at least two positions. In a first position, the ram is engaged against the peristaltic tube, pressing the tube against the housing of carriage 30, thereby closing the tube by pinching. In the second position, the ram is disengaged, and tube 212 is not deformed. Each elongate ram optionally may be disposed in carriage 30 to engage multiple tubes 212 simultaneously. The tubes may be in groups of 4, 8, 16 or other numbers, chosen to feed an equivalent number of reservoirs in parallel on the microfluidic device. A precision actuator, such as a hydraulic piston, a pneumatic piston, spring, or some other actuator, may drive these pistons. The pistons may be each contained within a separate housing compartment to ensure alignment and prevent movement in directions other than the direction of engagement.

Flat diaphragm 242 is fitted over piston 214a, flat diaphragms 248 and 250 are fitted over the end of pistons 216a, and flat diaphragm 252 is fitted over the end of piston 218a. The piston/diaphragm associated with each ram are offset from the adjacent ram or rams. When an encapsulated area behind each diaphragm is pressurized with a liquid or gas, the piston is driven forward, engaging the ram against the peristaltic tube. This configuration provides a very flat assembly for the aspiration/dispense unit.

A buffer source is upstream from tube 210. This source may be a buffer reservoir remote from carriage 30. In this case, buffer tubes 210 may be linked at a manifold to a single buffer reservoir. Alternatively the buffer source could be a cartridge carried on carriage 30. Buffer moves from a buffer source through tubes 210 into peristaltic tubes 212 and is dispensed from needles 32c.

The processes of aspirating and dispensing sample material can be performed as follows. To begin the process, peristaltic tube 212, tubing 32a and needle 32c are all filled with buffer from tube 210. Needle 32c is filled to its tip with buffer. All three rams are engaged against peristaltic tube 212. With pinch-off ram 214 closed, liquid is retained in the needle 32c due its narrow. In the first step in the aspiration and dispense process, the tip of needle 32c is open to air as airgap ram 218 is disengaged, drawing a small bubble of air into the tip of needle 32c, where the volume of the air bubble corresponds to the volume displaced in the peristaltic tubing by the airgap ram. Next the tip of needle 32c is placed into a liquid sample. Dispense ram 216 is disengaged, drawing a precise amount of sample into the tip of needle 32c, where the volume of the sample is the volume displaced in the tubing by the dispense ram when engaged. The bore volume of needle 32c and tubing 32a will be designed to be sufficient to contain the volume of both the air bubble and the aspirated sample. Pinch-off ram 214 prevents liquid from being drawn in from the buffer delivery tube 210.

In FIG. 3B, a filled needle in the sample aspiration/dispense unit is shown. Needle 32c is partially filled with sample liquid 222. The buffer 220 filling peristaltic tube 212 and part of needle 32c is separated from sample 222 by air bubble 224. Air bubble 224 is retained in needle 32c and will not move into peristaltic tube 212. Air bubble 224 also prevents sample 222 from diffusing into buffer 220.

Once the sample is aspirated into the needle from the sample array 12, the aspiration/dispense unit is moved so that the needle tips are proximate to reservoirs where samples are to be dispensed. The dispense ram 216 is engaged, dispelling the samples into a row of reservoirs. The aspiration/dispense unit is then raised, removing the needle tips from the sample material in the reservoirs, and moved to the wash station for cleaning prior to transfer of the next set of samples from the sample array. Once tips have been lowered into receiving wells of a multi-point wash station, the airgap ram is engaged to expel the air bubble in the tip. With the airgap ram engaged, the pinch-off ram and displacement ram are disengaged. Peristaltic tube 212 expands, drawing liquid into the tube from buffer tube 210. Pinch-off ram 214 is engaged, airgap ram 218 is disengaged, and dispense ram 216, followed by airgap ram 218, are then engaged, dispensing buffer out of the tip and into the wash station. Where necessary, the steps of 1) disengaging the pinch-off ram and displacement ram, while keeping the airgap ram engaged, 2) engaging the pinch-off ram, 3) disengaging the airgap ram, and 4) engaging the dispense ram, then the airgap ram, may be repeated to further rinse the tips.

In an alternative application, both a sample and a buffer can be dispensed without having to move and refill the aspiration/dispense unit. This is affected with a positive displacement dispenser, which dispenses the first fluid without requiring that the system be primed with it. In this application, the aspiration/dispense unit is primed with buffer, and the sample is aspirated from a sample array and dispensed into a microfluidic device as described above. Where it is advantageous to subsequently add buffer from the primed aspiration/dispense unit, the tips are raised out of the samples and the airgap ram engaged to expel the bubbles in the tips, bringing buffer to the tip of the dispense needles. The unit is again lowered into reservoirs of the microfluidic device, and the steps described above for dispensing buffer into the multi-point wash station are followed to dispense buffer into the sample reservoirs. These steps include 1) disengaging the pinch-off ram and displacement ram, while keeping the airgap ram engaged, 2) engaging the pinch-off ram, 3) disengaging the airgap ram, and 4) engaging the dispense ram. Finally, the aspiration/dispense unit is moved to the multi-point wash station for rinsing the tips prior to the next round of sample addition.

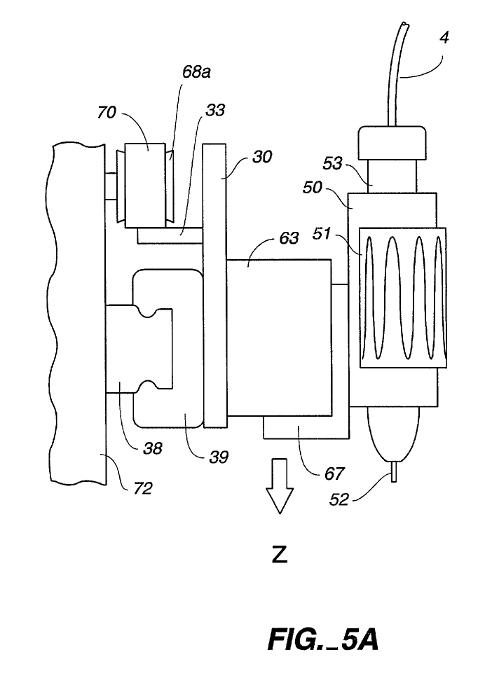

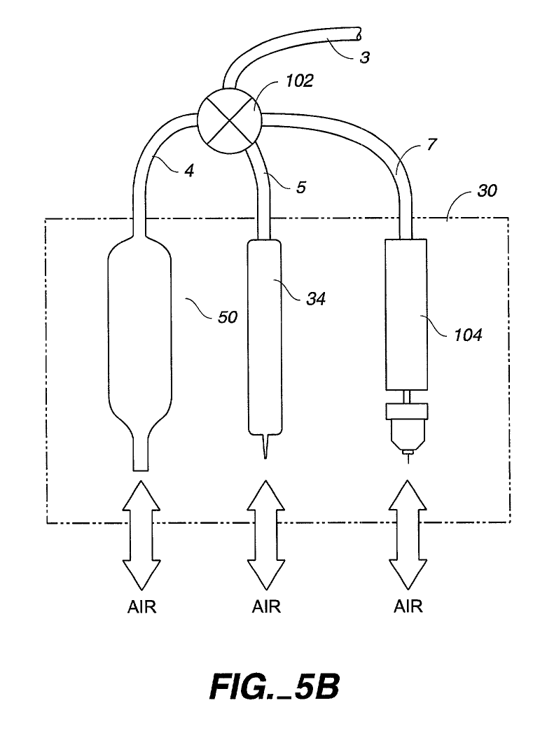

In alternative embodiments the sample aspirator and the buffer dispenser could be separate tools, wherein the buffer dispenser is solely dedicated to dispensing buffer, and the aspiration/dispense unit is solely dedicated to transferring sample material. A separate buffer dispenser could be affixed to a carriage or otherwise attached to the system. The dispensing force could be precision air, as described below in reference to FIG. 5B, positive displacement, as illustrated with FIG. 3, or a syringe plunger.

A separation medium dispenser 50 is also shown attached to carriage 30. This unit is optionally temperature-regulated, to allow heating the liquid dispensed when the medium used is otherwise resistant to flow into a microchannel, such as with a meltable gel. Heat control from 25-60° C. is employed. Line 64 provides a pressurized gas to dispenser 50 to provide the motive force for dispensing. A 2-15 psi dispense pressure is envisioned, and two to ten microliters of liquid is dispensed. This should allow for a dispense time of 5 millisecond to 5 seconds, depending on liquid viscosity. Additional means for providing a motive force for dispensing that are useful in the present invention include pumps, e.g., syringe pumps, a pneumatically-actuated dispensing cartridge, and a mechanically-actuated dispensing cartridge. The embodiment of the dispenser shown in the figure comprises a single medium dispensing line, which terminates at a medium dispense tip 52 at the end of unit 50. The entire dispenser may be moved along the z-axis by actuator 63 to bring the tip 52 into functional proximity with a reservoir on a microfluidic device 22. Dispenser 50 may dispense liquid agarose or any other low to medium viscosity buffer. Separation medium dispensers having more than one dispensing tip are also contemplated.

When a heated viscous liquid is dispensed into a reservoir of a microfluidic device, the device may be heated to prevent the gel from solidifying before completely filling the microchannel. Temperature regulation device 26 under the microfluidic device 22 heats the device to a specified temperature at which the liquid will flow into the microchannel. Temperature control from 10-60° C. is preferred for the microfluidic device temperature regulator. It may further be required that stages 10, 20 are thermally decoupled to allow for separate temperature control of the microfluidic device 22 and a sample array 12.

The separation medium dispenser 50 may conveniently comprise a fluid-containing cartridge providing fluid to the respective module. Additionally, the carriage to which these the separation medium dispenser is attached may optionally comprise a hinged compartment fitted to receive a fluid-containing cartridge serving the other dispenser.

An alternative embodiment of a buffer dispenser or a medium dispenser is illustrated in FIGS. 4A-E. In FIG. 4A, a clamshell clamp 120 comprises a heater 122 adjoined to a contoured heat transfer form 124. The heat transfer form 124 is made of an efficient heat-transferring material, such as aluminum, that provides for efficient and even heat transfer from heater 122 to the cartridge 130 inserted into clamp 120. The two sides of clamp 120 are joined by a hinge 126, simplifying exchange of cartridges in this clamp. A buffer cartridge 130 is inserted into the clamp. The buffer cartridge may be disposable, plastic molded syringes, and may be pre-filled with a buffer, reagent, meltable gel, or other liquid. Buffer cartridge 130 has a number of syringe bores 131-138 filled with a liquid or meltable solid, such as a buffer, reagent, or meltable separation media. Clamp 120 may close over cartridge 130. This module may be mounted on a transfer carriage and moved relative to a microchannel opening to provide liquid for dispensing into the openings of a microchannel.

As shown in FIGS. 4B, C and D, a plunger 140 mounted on the system may be inserted into bore 131 on cartridge 130. As the plunger advances in bore 131, a precise amount of buffer is dispensed from bore 131 through tip 32. Tips 32 could be preformed dispense tips or could receive a compatible tip, needle, or similar replaceable dispense tip. A stepper motor may be used to drive plunger 140 to provide for dispensing precise volumes of liquid. Individual plungers may be used, as shown in FIGS. 4B and C. Alternatively, the plungers could be arranged for simultaneous operation, as shown in FIG. 4D. In this embodiment, plunger 140 is attached to bar 142, the movement which is controlled by a stepper motor. Each plunger attached to bar 142 is inserted into a syringe bore of cartridge 130. As shown in FIG. 4E, the cross section of clamshell clamp 120 shows two forms 124a, 124b connected by hinge 126. Heaters 122 transfer heat to the heat conducting material composing forms 124a, 124b. Cartridge 130 is encased by forms 124a, 124b. Heat may be efficiently transferred into the liquids contained in bores 131-134.

Priming Block

In addition to heating the microfluidic device, an active force may be needed to force viscous liquids into the microchannel. This function is provided with a priming block 104 mounted on actuator 102 is illustrated in FIG. 1C. Two embodiments of the bottom surface of the priming block are shown in FIGS. 1D-1F, representing priming blocks that operate to prime 8 or 16 microchannels simultaneously. The priming block 104 connects to the surface of the microfluidic device, surrounding a plurality of priming reservoir openings to which solution has been added. The individual channels 105 of the priming block are formed within a compressible material 109 that serves to seal the bottom of the priming block against the surface of the microfluidic device, surrounding the priming reservoirs. An electrode 107 may optionally be provided within each of the individual channels. This design enables the use of either or both air pressure and an electromotive force simultaneously for forcing liquid from the priming reservoirs into the microchannels.

After operatively connecting to the device, the priming block functions to provide a force that moves liquid from a priming reservoir into one or more microchannels fluidly connected to the reservoir. The priming block is able to act on a plurality of priming reservoirs simultaneously. For purposes of illustration, and not intending to limit the scope of the invention, the embodiment illustrated acts to seal against sixteen priming reservoirs simultaneously, as shown in FIGS. 1D, thereby priming all of the microchannels connected to the sixteen reservoirs. In alternative embodiments as a matter of convenience, the priming block may prime different numbers of reservoirs, including, 2, 4, 8 or other multiples. An embodiment priming eight reservoirs is shown in FIG. 1F. In alternative embodiments, multiple priming reservoirs may be primed from a single microchannel formed in the compressible material of the priming block. An example of this design is shown in FIG. 1E, in which 16 priming reservoirs are primed from 4 individual microchannels.

The individual channels 105 may all be controlled by a single pressure source, or alternatively may each be separately controlled by distinct pressure sources. For example, the priming block of FIG. 1D may couple subsets of the sixteen individual channels 105 functionally connected to individualized sources of pressurized gas, such as two sets of eight individual channels. Where an electromotive force is employed, the microfluidic device holding stage 20 on the platform 14 will further comprise a fully or partially electrically grounded plane. Where both air pressure and electromotive force are employed, the priming pressure and voltage may be sequenced so as to optimally prime the microchannels without entrapping air bubbles. Additionally, the priming pressure and voltage may be sequenced so as to optimally prime the microchannels introducing a minimum of priming fluid into the sample reservoirs. Alternatively, electromotive force may be solely employed, obviating the requirement for the compressible material 109 and the pressurized air source.

The priming block 104 is joined to belt 70 such that priming block 104 may be moved specified location. At this location actuator 102 may lower priming block 104 over openings into microchannels on the microfluidic device 12 such that priming block 104 seals over these openings. In the illustrated system, priming block 104 is mounted on the opposite side of the gantry wall 72 as the carriage 30 (as shown in FIG. 1A). Precision motor 60 allows precise movement of priming block 104 to a location over openings into microchannels. Wash stations may also be used with module 40. The wash stations are positioned on the platform 14 of module 40, and may be used for washing any or all of the tools used with the module. In FIG. 1A, two wash stations are shown. Multi-point wash station 80 is used to clean the tips 32 of the aspiration/dispense unit 34. In addition, separation medium dispenser wash station 31 may be used to clean the tip 52 of the separation medium dispenser 50. Wash station 31 optionally uses heated fluid to clean tip 52, allowing meltable viscous fluid to be removed from tip 52. Multi-point wash station 80 may also use heated fluid, where such use improves cleaning. The wash fluid may be water or another low viscosity liquid. Any or all of the wash stations may be designed to provide a continuous flow of rinse liquid, either by recirculation or continuous fluid exchange.

After filling the microchannels of a fluid network, some part of the fluid network may prove to be non-operational for conducting an electrophoretic separation. One type of artifact frequently encountered is the formation of bubbles within the microchannels when they are filled. This problem arises due to the extremely small cross-sectional area and high surface-to-volume ratio of microchannels. A bubble in the circuit can have the impact of impeding or even preventing the flow of current through the microchannel. Consequently, an important functionality within a high-throughput system utilizing microfluidic devices is a mechanism for detecting and acting on bubbles trapped in the filled microchannels.

The system of the present invention also optionally comprises a mechanism for determining if a filled microchannel is operative for an electrophoretic separation. After a fluid network has been filled, it may be tested for operativity by measuring any one of a number of physical characteristics. Some of the physical properties that may be employed for testing the operativity of a filled microchannel include resistance, light transmission, capacitance, optical appearance, or sonic or ultrasonic properties.

An embodiment for testing using resistance to current is to apply a given amount of voltage across the microchannel after it is filled. An unobstructed microchannel should yield a constant amount of current, while an obstruction in a microchannel will be observed as a reduction or fluctuation in the current. Such a testing system comprises a power source for applying a voltage across the microchannels, and a detector for monitoring the current generated by the voltage.

Light transmission may also be used for testing. One embodiment comprises monitoring light transmission across a microchannel. Such a testing system comprises a light source for directing light across the microchannels and a detector for monitoring the light, wherein the light source and the detector are disposed on opposite sides of the microchannels. Either scatter or absorption of light can be employed. Where a microchannel is unobstructed, the amount of transmitted light will be constant. The presence of an obstruction in a microchannel will be seen as a change in the amount of light transmitted as the light source is scanned along the microchannel.

Electrical capacitance may also be used to test for proper filling. A capacitor is an electrical device used for storing electric charge. A basic capacitor design consists of two parallel conducting surfaces separated by an insulating layer called a dielectric. In the instant case, the conducting surfaces are embodied by conductive medium in the microchannel and the grounded metal plate upon which the card is resting, and the dielectric is provided by the thin plastic substrate covering the microchannels, which is typically 40 μm thick. To test for operability, an electrode (preferably that which is part of the priming block) is inserted into a reservoir connected to the microchannel to be tested. An electrical circuit measures the capacitance between the electrically conductive liquid in the primed microchannels and the grounded metal plate. Improperly filled microchannels will display lower capacitance relative to correctly filled microchannels.

Optical monitoring of the operability of a filled microchannel may be performed by using a CCD camera to acquire an image of each microchannel pattern. Pattern recognition software is then used to locate any air bubbles or other inclusions that exceed a pre-set size criteria.

Sound-based or ultrasound-based inspection technology can be used to locate enclosed voids such as air bubbles in the filled microchannels. Commercial equipment for this purpose exists for, e.g., nondestructive testing of composite material structures. The basic principle of these systems employs an acoustic “radar” to locate inclusions, seen as changes in reflectivity or transmissivity of the substrate that result from changes in density.

Where an inoperative microchannel is detected, the system may be operated to respond in one of several ways. The device may be recycled through the priming process to refill any microchannels found to be inoperable. Alternatively, the system may simply make a record of the position of the inoperative microchannel, or may discard the microfluidic device altogether. These last two options will be most viable in a fully automated, high throughput system.

Component Integration

The movement and operation of the carriage and carriage tools are further illustrated in FIGS. 5A and B. With reference to FIG. 5A, carriage 30 is mounted on carriage guide 39. Carriage guide 39 is slidably mounted on carriage rail 38, which is affixed to gantry wall 72. Extending perpendicularly from carriage 30 is carriage mount 33, which extends above carriage guide 39. Carriage mount 33 is affixed to belt 70. When a precision motor rotates pulley 68a, the belt 70 and mount 33 are reciprocated along the x-axis (perpendicular to the perspective given in FIG. 5A). The tools on the carriage must be accurately positioned over the microfluidic device to ensure that dispensing devices dispense into the associated opening of a reservoir. A left/right positional accuracy of +/−0.01 inch is desired. HTD profile pulleys and belts should allow for this accuracy tolerance.

Actuator 63 is mounted on carriage 30, and may move arm 67 up and down along the z-axis. The separation medium dispenser 50 is mounted to arm 67. Actuator 63 is able to repeatedly lower and raise the separation medium dispenser to bring this unit into contact with the openings of microchannels. It is desired that the actuator have an accurate vertical motion, as would be obtainable using available commercial devices, such as, e.g., a Robohand MPS 1-1 (Robohand Inc., Monroe, Conn.). The separation medium dispenser includes a pressure line 4 providing a precision propellant force into priming reservoir 53. Heater 51 has heated the liquid in this reservoir so that the liquid has a sufficiently low viscosity to allow the liquid to be dispensed from the tip 52. For example, certain types of agarose gel solidify at 42° C., requiring heating above this temperature to dispense agarose. When actuator 63 lowers arm 67, tip 52 is brought into proximity with a priming reservoir that is part of a fluid network in the microfluidic device. Air pressure line 4 introduces a precision controlled air pressure for a controlled duration to dispense a precise amount of liquid from tip 52. The amount of liquid dispensed may be matched to the volume of the microchannel to provide for sufficient liquid to fill the microchannel without extruding liquid from an opening on a distal end of the microchannel. After dispensing, a slight vacuum may be applied through tube 4 to avoid dripping from tips 52.

The present system has the advantage of being adaptable to a number of different configurations of the tools required to prepare microchannels. For example, the priming block and the separation medium dispenser may not be mounted on a movable carriage, as these tools are used solely with the microfluidic device. Alternatively, as shown in FIG. 1C, some tools could be mounted on the carriage on the front side of the gantry wall 72, while other tools may be mounted on the opposite side of the gantry wall. In another embodiment, multiple tools may be mounted on the carriage, with all of the tools linked to a common source of precision air pressure.

FIG. 5B illustrates an integrated control array for controlling the function of each of the tools of the system by pressure. A separation medium dispenser 50, an aspiration/dispense unit 34 and a priming block 104 are mounted on carriage 30. These tools are connected to pressure lines 4, 5, and 7 respectively. Precision pressure line 3 provides precision air displacement, which may be selectively directed into lines 4, 5, and 7 by a selector valve 102. In this way a single source of air may be used to supply the precision displacement force for a number of tools. Although these tools are illustrated as all being mounted on a carriage, it is also envisioned that one or more tools could be located off the carriage, attached at a fixed position along the x-axis. The three tools listed are illustrative. In alternative embodiments the sample aspirator and the buffer dispenser could be separate tools, both supplied by the single precision air source. Additionally, other tools may be incorporated into the system, which may also be controlled by the same or a separate air source.

The various tools and components of the system described are preferably operated on a fully automated platform. Movement and operation of the tools within the system may be computer-controlled, allowing for remote operation. Furthermore, program routines may be developed for standardized microfluidic device preparation. As will be described in more detail below, this microfluidic device preparation system may be integrated into a larger system that includes, for example, a mechanism for preparing sample arrays containing samples to be added to the microfluidic devices, and a separation and analysis platform for conducting the electrophoretic separations and collecting data. These different functionalities may be integrated into a single system, or may be separate devices. Where separate devices provide the functions, they can be functionally integrated through use of robotic handling of materials, e.g., to move a sample array from a preparation station to the preparation system, or to move prepared microfluidic devices to the separation and analysis system.

Functionalities of the System

The present invention includes methods for use of the systems described herein. A method for preparing a plurality of separation microchannels in a microfluidic device comprises the steps of (a) dispensing separation medium into the appropriate priming reservoirs, (b) sealing a priming block against the priming reservoirs, (c) driving fluid into the microchannels with the priming block to fill the fluid networks, and (d) transferring samples from a sample array to appropriate reservoirs connected to the plurality of filled separation networks within the filled fluid networks. In preparing the microfluidic device, the system may optionally operate to fill a single microchannel, or convenient multiples of microchannels, such as a row of 8 or 16.

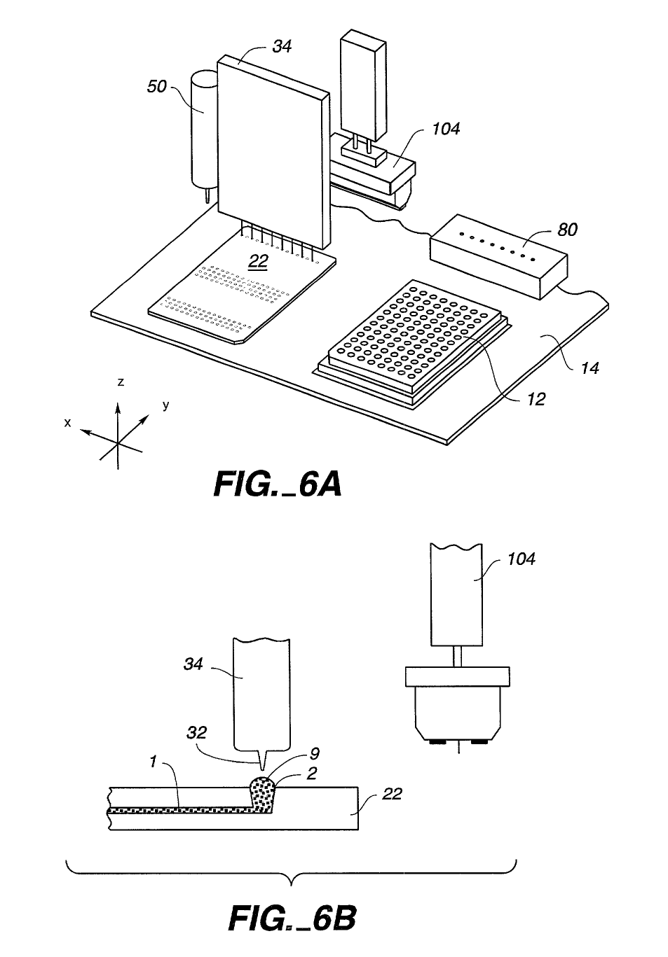

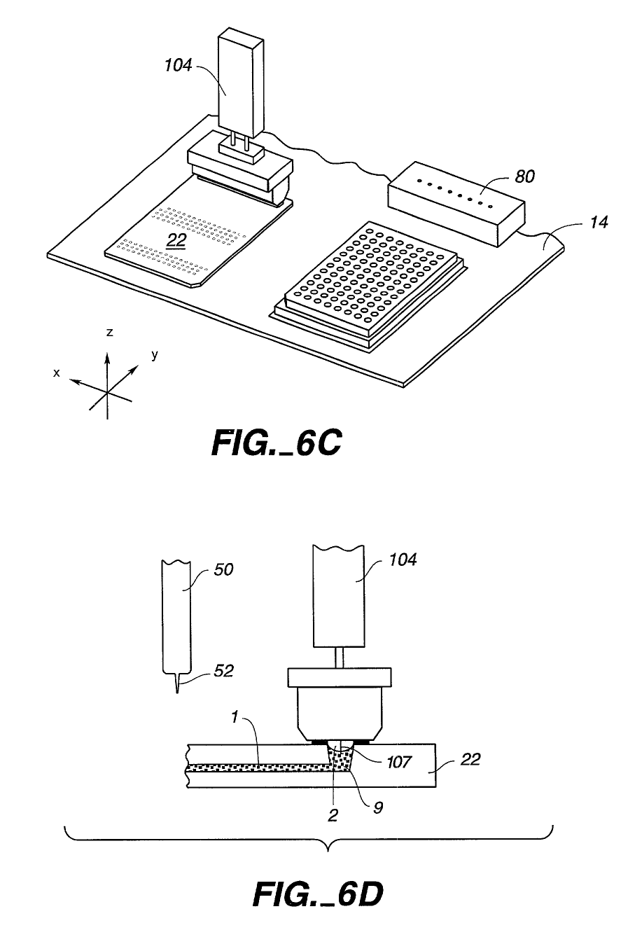

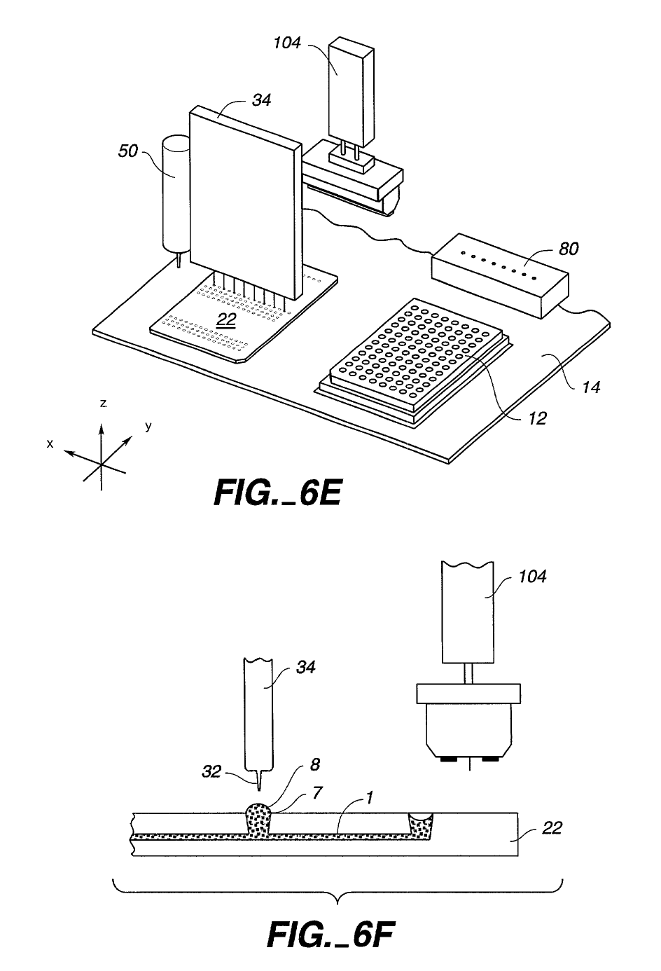

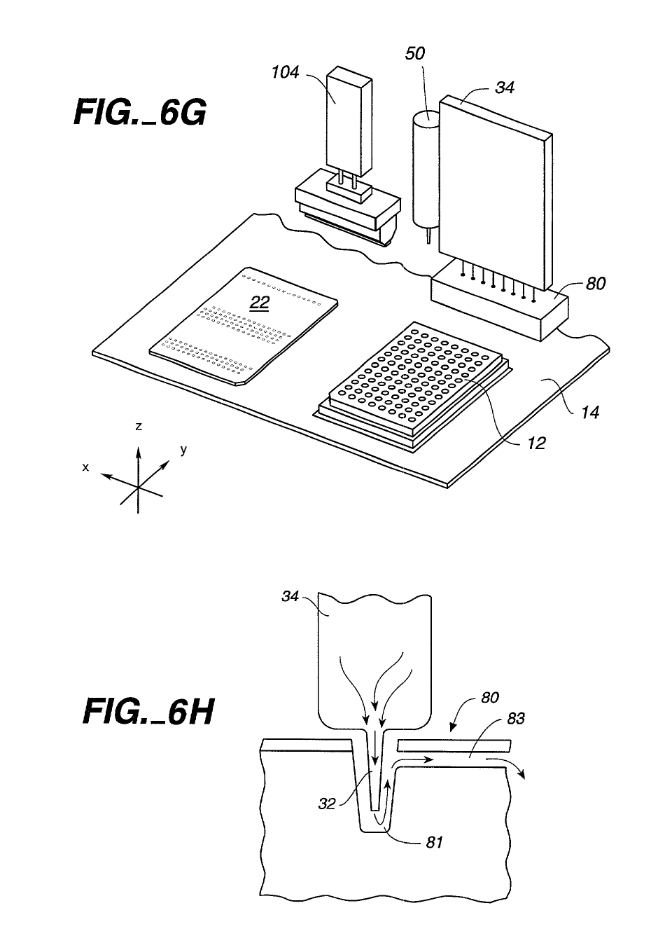

The steps in the process of filling microchannels with a dispensed separation medium, sample, and buffer are illustrated in FIGS. 6A-6I. In FIG. 6A, a microfluidic device 22 on platform 14 has a row of priming reservoirs that open into a row of fluid networks. The openings are brought into alignment with the tips of the tools mounted on the carriage of the system by lowering the tools carried on the carriage toward platform 14. In FIG. 6B, microchannel 1 is shown having a priming reservoir 2. Separation medium 9 is dispensed from the separation medium dispenser 50 into a row of priming reservoirs 2 connected to a row of fluid networks. Tip 52 is brought proximate to priming reservoir 2 to ensure that the liquid is dispensed only to the priming reservoir 2. Several forces, including electrostatic force, surface tension, or viscosity may act to prevent buffer 9 from flowing into microchannel 1. Where the separation medium dispenser 50 has a single tip, separation medium will be dispensed to the row of priming reservoirs in series. Other embodiments of the separation medium dispenser 50 are contemplated comprising multiple dispense tips 52, providing for dispensing to multiple priming reservoirs simultaneously. In the present illustration, separation medium is dispensed into a row of eight priming reservoirs.

Referring to FIGS. 6C and 6D, platform 14 is moved relative to priming block 104 such that the priming block 104 is sealed over the filled priming reservoirs 2 of the microfluidic device 22. In the present illustration, the priming block 104 will seal over a row of eight reservoirs to fill the microchannels of eight fluid networks simultaneously. In FIG. 6D, an individual channel of a row of channels on the priming block 104 is sealed over the opening to the priming reservoir 2, fluidly connected to microchannel 1 on the microfluidic device 22. The priming block 104 functions to provide a force to drive the liquid from the reservoir into the microchannels in fluid connection with the priming reservoir. In the present illustration, the forces used are electromotive force and pressure, although these forces, or other types of forces, may also be used singly. Electrode 107 extends through opening 2 into liquid 9. Electrode 107 provides an electromotive force through liquid 9 while pressure is introduced through chamber 105. A selectable electromotive force from 1000-4000 volts and a primary pressure from 2-60 psi are preferred. The combination of electromotive force and pressure drives liquid 9 into microchannel 1.

In FIG. 6E, platform 14 is again moved in the direction of the y axis, moving aspiration/dispense unit 34 over a second row of reservoirs in fluid connection to the filled separation networks in the microfluidic device 22. Aspiration/dispense unit 34 is then lowered over the microfluidic device 22 such that the dispense tips may introduce buffer into the empty rows of reservoirs in fluid connection to the row of filled separation networks. In FIG. 6F, one tip 32 of aspiration/dispense unit 34 is shown proximate to a reservoir 7 on the microfluidic device 22. A buffer 8 is dispensed through tip 32 into reservoir 7. The liquid in reservoir 7 can protect medium in microchannel 1 from evaporation. Because the liquid does not move into the microchannel, further active priming is not needed.

In FIG. 6G the cleaning of the dispense tips is illustrated. Platform 14 is moved and aspiration/dispense unit 34 is lowered such that the tips on this unit are inserted into receiving ports on a multi-point wash station 80. In FIG. 6H, the washing of tip 32 is shown. Port 81 on wash station 80 receives tip 32 on aspiration/dispense unit 34. A wash liquid, such as the buffer (e.g. HEPES), is pumped through tip 32 and vacuum scavenged through port 83 thereby cleaning tip 32. With sufficient rinsing can result in less than 1 part in 100,000 residual contamination. Similarly, the tip of the separation medium dispenser 50 may also be cleaned, when necessary, by lowering the tip into the receiving port of the separation medium dispenser wash station 31.

After the microfluidic device has been filled with separation medium and buffer, platform 14 is again moved to bring the aspiration/dispense unit 34 over a row of samples in the sample array 12. The aspiration/dispense unit 34 is lowered over the sample array such that the dispense tips may aspirate sample liquid from the row of samples. FIG. 6I illustrates a plan for the transfer of samples from a sample array 12 to the microfluidic device 22. The lines indicate the corresponding positions on the plate and device during transfer by the aspiration/dispense unit 34. The platform 14 is again moved to bring the aspiration/dispense unit 34 over the row of sample reservoirs in fluid connection to the filled microchannels in the microfluidic device 22. Aspiration/dispense unit 34 is then lowered over the microfluidic device 22 such that the dispense tips may introduce sample into the sample reservoirs. Following transfer, tips 32 may be washed in the wash station 80 as described in conjunction with FIGS. 6G and 6H. The device is now ready for transfer to an analyzer for separation and analysis of the prepared separation microchannels.

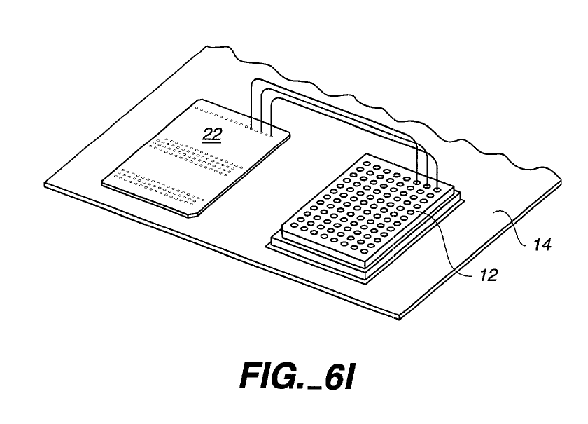

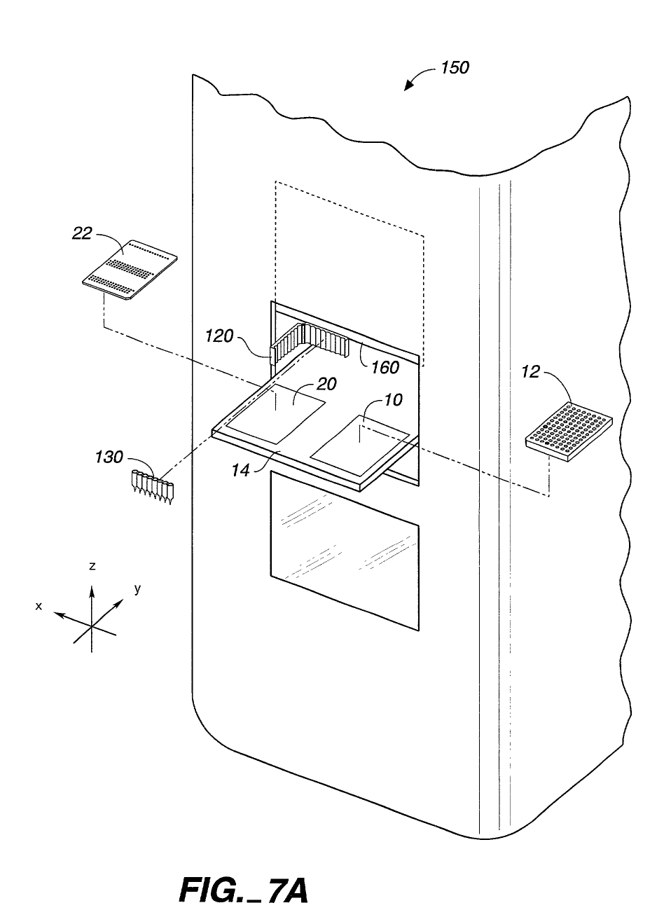

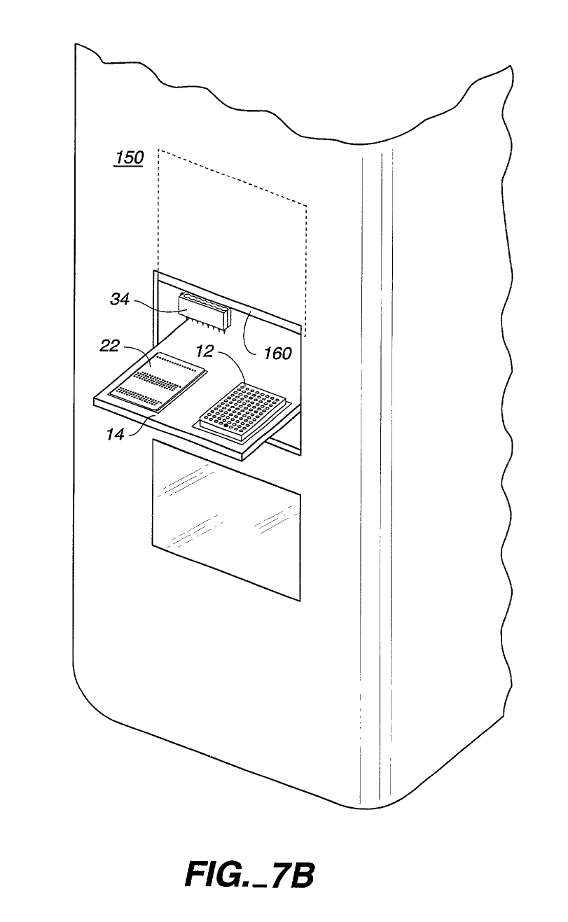

In FIG. 7A, the consumable components are shown on microfluidic device preparation system 150. Preloaded buffer cartridge 130 is loaded into clamshell clamp 120. Microfluidic device 22 and sample microplate 12 are loaded onto their respective stages 20, 10 on platform 14. Microfluidic device 22, sample microplate 12 and cartridge 130 may be loaded robotically, aiding in system throughput. Platform 14 can then retract into system 150 and door 160 lowered.

The steps of dispensing separation medium to a row of priming reservoirs in fluid connection with a row of fluid networks, driving the medium into microchannels with the priming block, filling the remaining reservoirs of the row of fluid networks with separation buffer, and adding samples to the sample reservoirs of the row of separation networks is repeated until all separation networks of the microfluidic device are prepared for electrophoretic separation and analysis of the samples added to the device. The microfluidic device may be transferred to a separate analytical unit where components within the samples are separated in the microchannels and targets detected, or the preparation system 150 may also incorporate an analysis system in order to integrate functions and reduce the need for microfluidic device handling. Where the analysis is performed in a separate system, the same robot that transferred the sample microplate and microfluidic device into the preparation system 150 may be used to transfer the plate to the analytical unit. In FIG. 7B, the vertical door 160 is open and platform 14 extends from the system. Aspiration/dispense unit 34 is positioned within system 150 to transfer sample and reagents or other liquids from sample microplate 12 to the microfluidic device 22. This system provides simplified mechanics and encloses the microfluidic device during preparation for enhanced safety. The vertical door 160 minimizes obstructions to the user or system robotics.

The methods of the invention can be performed using semi-automated or automated formats. Those skilled in the art will know how to automate steps of sample addition, washing and data analysis, including automated identification of particular cleaved uniquely identifying tags present in an element of an array.

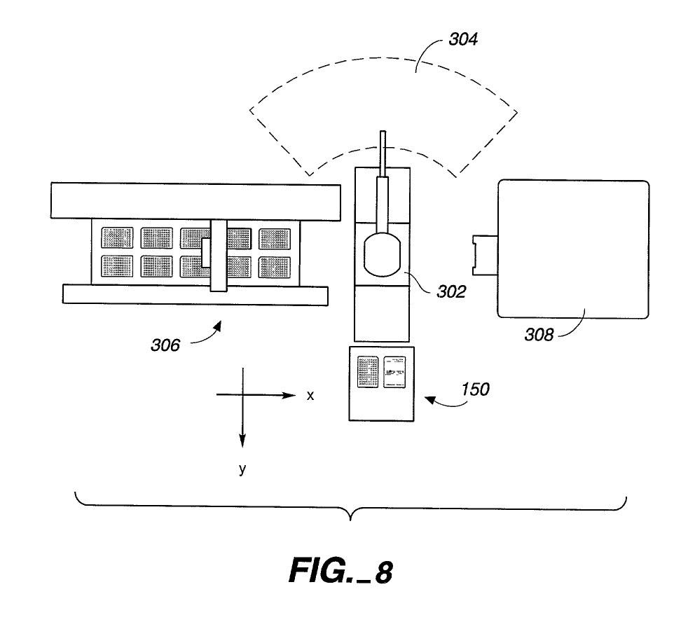

An integrated system for sample preparation and analysis, including microfluidic device preparation and analysis, is shown in a top view in FIG. 8. This system is comprised of a number of component subsystems. Sample arrays are prepared, using an automated sample preparation module 306. Many commercially available systems may be used, such as, e.g., a BioMek® laboratory automation workstation (Beckman Coulter) or other available sample preparation systems. Once a sample microplate is prepared, the plate is transferred to sample queue 304 by robot 302, e.g., a Twister™ Universal Microplate Handler (Zymark Corp., Hopkinton, Mass.) or other similar robot. Robot 302 transfers completed sample arrays from queue 304 to microfluidic device preparation system 150, which prepares the microfluidic device for analysis, including filling microchannels within the device and transferring samples from the sample array to appropriate reservoirs on the device. Once the microfluidic device is prepared, robot 302 transfers the microfluidic device to an analytical system 308. In this system, samples may be electrophoretically separated, then optically scanned or otherwise analyzed.

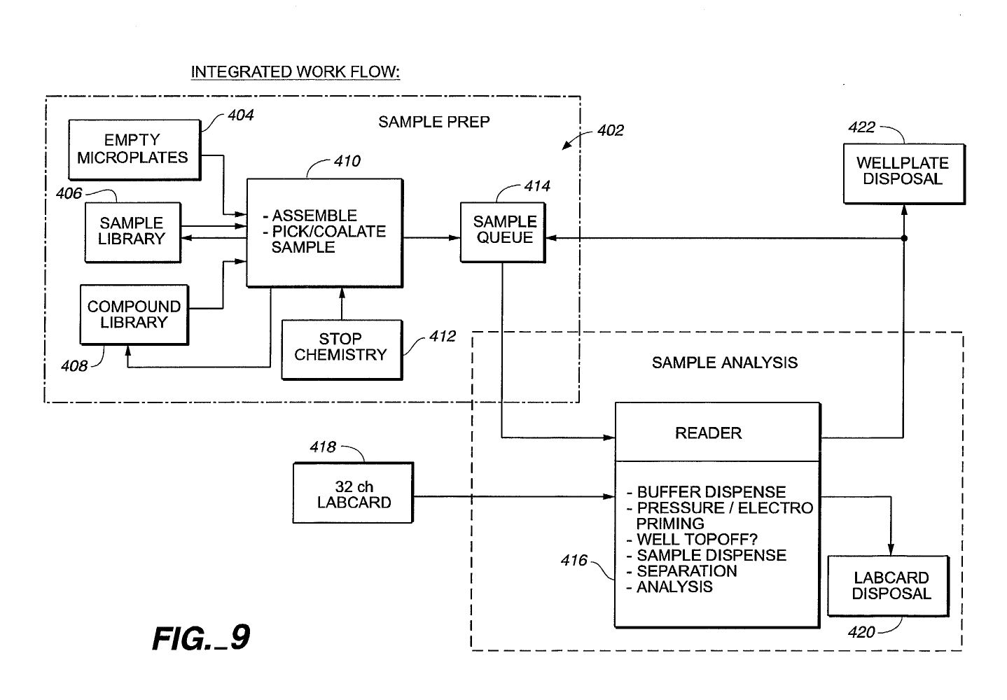

The workflow of the integrated system shown in FIG. 8 is illustrated in a flow diagram in FIG. 9. In the sample preparation phase, empty multiwell microplates (e.g. 96-well plates) 404, plates holding prepared mixtures from a storage location 406, and plates holding compounds from a compound library 408 are transferred to the sample preparation system 410. The system 410 assembles sample components into sample preparations to be analyzed. Such sample assembly could include cell lysis and extraction of components (e.g. proteins, DNA, RNA) from the cell lysate, amplification of nucleic acids (e.g. by polymerase chain reaction), or reagent mixing. In some preparations a reagent is added to stop a reaction (e.g. deactivate unreacted reagents, denature enzymes, etc.), which is sourced from an adjunct reagent station 412. Some of the plates holding samples may be returned to the storage location 406 and compound library 408 for later preparation and analysis. Prepared sample arrays are added to the sample queue 414. Sample arrays from the queue 414 are then transferred to microfluidic device preparation and sample analysis system 416. A microfluidic device is transferred from microfluidic device station 418 to microfluidic device preparation and analysis system 416. In system 416, buffer or separation media is dispensed into reservoirs connected to separation networks in the microfluidic device. An active force (e.g. pressure, electromotive priming) is used to move liquid into the microchannels. Reservoirs are topped off with a buffer, and samples are transported to the appropriate sample reservoirs on the microfluidic device. The samples then may be separated, as by electrophoresis, and analyzed. Once all of the needed samples have been transferred from a sample array, the sample array containing unused sample may be disposed of at the disposal station 422, or returned to the sample array queue 414 for additional use. Once the microfluidic device has been analyzed, it may be transferred from system 416 to a microfluidic device disposal station 420. The various components of the system are preferably operated on a fully automated platform. Each of the separate functionalities of the system is amenable to computer control, allowing for remote operation, and full integration of the various subsystems into a complete system.

All publications and patent applications cited in this specification are herein incorporated by reference in their entirety. Although the foregoing invention has been described in some detail by way of illustration for purposes of clarity of understanding, it will be readily apparent to those of ordinary skill in the art in light of the teachings of this invention that certain changes and modifications can be made thereto without departing from the spirit or scope of the appended claims.

What is claimed is:

1. A priming block for filling a plurality of fluid networks contained in a microfluidic device, each fluid network being externally and fluidly accessible through a priming reservoir, the priming block comprising:
(a) means for operatively connecting with a plurality of the priming reservoirs, and
(b) means for driving fluid into the plurality of fluid networks upon making the operative connection, thereby to fill the plurality of fluid networks.

2. The priming block of claim 1, wherein said means for driving fluid comprises at least one of air pressure and electromotive force.

3. The priming block of claim 2, wherein said air pressure further comprises:
(a) a source of pressurized air;
(b) a pressure line connecting the source of pressurized air to said priming block; and
(c) a valve within the pressure line that regulates delivery of pressurized air from the source to said priming block.

4. The priming block of claim 2, wherein said electromotive force further comprises an electrically grounded plane positioned against the face of said microfluidic device opposite of said priming reservoir.

5. A system for filling a plurality of fluid networks contained in a microfluidic device, each fluid network being externally and fluidly accessible through a priming reservoir, the system comprising:
(a) a platform for positionally holding the microfluidic device; and
(b) a priming block comprising:
(i) means for operatively connecting with a plurality of the priming reservoirs when the microfluidic device is positioned on the platform, and
(ii) means for driving fluid into the plurality of fluid networks upon making the operative connection, thereby to fill the plurality of fluid networks.

6. The system of claim 5, wherein said platform further comprises means for regulating the temperature at said position for said microfluidic device.

7. The system of claim 5, wherein said means for driving fluid comprises at least one of air pressure and electromotive force.

8. The system of claim 7, wherein:
said means for driving fluid comprising air pressure further comprises
(a) a source of pressurized air,
(b) a pressure line connecting the source of pressurized air to said priming block, and
(c) a valve within the pressure line that regulates delivery of pressurized air from the source to said priming block;
and said means for operatively connecting comprises a compressible material on the connecting surface of said priming block, the compressible material providing a pressurized air seal between said priming block and said external openings of said priming reservoirs.

9. The system of claim 7, wherein:
said means for operatively connecting comprises a plurality of electrodes, each inserted by said priming block into one of said plurality of priming reservoirs, and
said means for driving fluid comprising electromotive force further comprises
(a) an electrically grounded plane positioned against the face of said microfluidic device on the opposite side of said priming reservoir, and
(b) a source of power that can be delivered to the electrodes.

10. The system of claim 5, further comprising:
(a) a gantry positioned above said platform, wherein said platform and the gantry are moveable relative to each other along a first axis;
(b) a carriage moveably mounted to the gantry, where the carriage motion is along an axis perpendicular to the first axis;
(c) a first moveable mounting means for mounting the carriage to the gantry, where the carriage motion is along an axis perpendicular to the first axis; and
(d) a second moveable mounting means for mounting said priming block to the carriage, where the motion on the carriage is in an axis perpendicular to the plane of said platform.

11. The system of claim 5, further comprising means for determining the operativity of each of the filled fluid networks for electrophoretic separations.

12. The system of claim 11, wherein the means for determining comprises components for monitoring a property of said microchannels, the property being one from the group including resistive, capacitive, optical, transmissive, sonic and ultrasonic properties.

13. The system of claim 12 for monitoring said property of resistance, the components comprising a power source for applying a voltage across said filled fluid networks, and a detector for monitoring the current generated by the voltage.

14. The system of claim 12 for monitoring said property of transmission, the components comprising a light source for directing light across said filled fluid networks, and a detector for monitoring the light transmitted across said filled fluid networks, wherein the light source and the detector are disposed on opposite sides of said fluid networks.

15. The system of claim 5, further comprising means for automated operation of said system.

16. The system of claim 5, wherein said platform is further functional to positionally hold both said microfluidic device and a sample array, and the system further comprises at least one fluid dispensing module that is movable to operative positions relative to said platform.

17. The system of claim 16, wherein said platform further comprises means for separately regulating the temperature at said positions for said microfluidic device and said sample array.

18. The system of claim 16, further comprising means for regulating the temperature of said fluid-dispensing module.

19. The system of claim 16, further comprising a wash station functionally accessible to said fluid dispensing module.

20. The system of claim 19, further comprising means for heating said wash station.

21. The system of claim 19, further comprising means for providing a flow of rinse liquid.

22. The system of claim 16, further comprising:
(a) a gantry positioned above said platform, wherein said platform and the gantry are moveable relative to each other along a first axis;
(b) a carriage;
(c) a first moveable mounting means for mounting the carriage to the gantry, where the carriage motion is along an axis perpendicular to the first axis; and
(d) a second moveable mounting means for mounting at least one of said fluid dispensing module and said priming block to the carriage, where the motion on the carriage is in an axis perpendicular to the plane of said platform.

23. The system of claim 22, further comprising a fluid-containing cartridge providing fluid to said fluid-dispensing module.

24. The system of claim 22, wherein said carriage has a hinged compartment fitted to receive said fluid-containing cartridge.

25. The system of claim 16, wherein said fluid dispensing module is selected from the group consisting of:
(a) an aspiration/dispense unit comprising a plurality of tips, the end of each tip movable into functional proximity to at least one of (i) a well in a sample array positioned on said platform and (ii) a reservoir on a microfluidic device positioned on said platform; and
(b) a separation medium dispenser having at least one medium dispensing line, each dispensing line terminating at a medium dispense tip that is movable into functional proximity to said priming reservoirs on said microfluidic device positioned on said platform.

26. The system of claim 25, wherein said aspiration/dispense unit further comprises eight tips mounted in parallel with a spacing of 9 mm between adjacent tips.

27. The system of claim 25, wherein said aspiration/dispense tips operate by positive displacement.

28. The system of claim 16, further comprising at least one from the group consisting of:
(a) a sample preparation module functional to prepare said sample array,
(b) a separation/detection module functional to separate components contained within said microfluidic device and detect the separated components, and
(c) an analysis module functional to collect and analyze data obtained from the detecting.

29. The system of claim 28, further comprising automated means for transferring between said modules either of said sample array and said microfluidic device.

30. A method for preparing a plurality of separation networks in a microfluidic device for a separation, each separation network being externally and fluidly accessible through a priming reservoir and a sample reservoir, comprising the steps of:
(a) dispensing separation medium into one or more of the priming reservoirs fluidly connected to a plurality of the separation networks;
(b) sealing a priming block against the one or more priming reservoirs;
(c) driving fluid into the plurality of separation networks with the priming block to fill the separation networks; and
(d) transferring a plurality of samples from a sample array to the sample reservoirs in fluid connection with the plurality of filled separation networks, thereby preparing the plurality of separation networks contained in the microfluidic device for a separation.

31. The method of claim 30, wherein said driving is achieved using at least one of air pressure and electromotive force.

32. The method of claim 30, wherein eight separation networks are filled simultaneously.

33. The method of claim 30, further comprising after step (c), the step (c-2) of determining the operativity of each of said filled separation networks for electrophoretic separations.

34. The method of claim 33, wherein said determining step comprises 10 monitoring a property of said separation networks, the property being one from the group including resistive, capacitive, optical, transmission, sonic and ultrasonic properties.

35. The method of claim 33, further comprising repeating steps (a) through (c) if one of said separation networks is determined to be inoperative.

36. The method of claim 33, further comprising the step of recording the position of any separation network determined to be inoperative.

37. The method of claim 33, further comprising the step of discarding said microfluidic device containing one of said separation networks determined to be inoperative.

38. The method of claim 30, further comprising the step of transferring said microfluidic device to an analyzer for separation and analysis of said prepared separation networks.

39. The method of claim 30, conducted automatically.
